(19) United States
(12) Patent Application Publication
(10) Pub. No.: US 2010/0123686 A1
(43) Pub. Date: May 20, 2010

(54) PIEZORESISTIVE FORCE SENSOR INTEGRATED IN A DISPLAY

(75) Inventors: Gunnar Klinghult, Lund (SE); Mats Kleverman, Helsingborg (SE)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communications AB, Lund (SE)

(21) Appl. No.: 12/356,858

(22) Filed: Jan. 21, 2009

Related U.S. Application Data
(60) Provisional application No. 61/116,118, filed on Nov. 19, 2008.

(51) Int. Cl. G06F 3/041

(52) U.S. Cl. 345/178; 345/173

(57) ABSTRACT

A device may include a substrate including an input device on a substrate and at least one piezoresistive sensor formed on the substrate outside the area of the input device. A device may include a display formed on a substrate, at least one piezoresistive sensor formed on the substrate, and a processor to calculate an applied force and activate a force response based on the calculated applied force. A method may include monitoring resistance associated with one or more piezoresistive sensors to detect changes in a force applied to a display device, detecting a change in resistance associated with the one or more piezoresistive sensors, calculate a force applied to the display device based on the detected change in resistance, activating a force response in proportion to the change in resistance detected, and displaying a result of the force response via the display device.

### CROSS REFERENCE TO RELATED APPLICATION

The instant application claims priority from provisional application No. 61/116,118, filed Nov. 19, 2008, the disclosure of which is incorporated by reference herein in its entirety.

### BACKGROUND

Many electronic devices use touch screens for user input. A touch screen sends a signal to the device when a user touches it with, for example, a finger. Many touch screens used in various devices are resistive touch screens. Resistive touch screens may be applied to different types of displays and are relatively inexpensive. However, resistive touch screens act as a simple switch, which limits an amount of control a user can exercise via a touch screen input device.

Furthermore, many electronic devices, such as mobile communication devices, have limited input and output capabilities due to their relatively small sizes. For example, many mobile communication devices have small visual displays and limited numbers of keys for user input. Given the increasing array of features included in mobile communication devices, the limited ability to interact with mobile communication devices can be increasingly troublesome.

### SUMMARY

According to one aspect, a device is provided. The device may include a substrate, an input device provided on a first portion of the substrate, and at least one piezoresistive sensor to sense a force applied to the input device, where the piezoresistive sensor is provided on a second portion of the substrate, where the second portion is different than the first portion.

Additionally, the at least one piezoresistive sensor may include a piezoresistive sensor located outside each corner of the input device, or a piezoresistive sensor located outside a middle of each edge of the input device.

Additionally, the at least one piezoresistive sensor may include a first pair of piezoresistive sensors formed in a deformable area of the substrate, and a second pair of piezoresistive sensors formed in a substantially non-deformable area of the substrate.

Additionally, the first pair of piezoresistive sensors and the second pair of piezoresistive sensors may be arranged in a Wheatstone bridge configuration.

Additionally, the at least one piezoresistive sensor may include a sensor having a zigzag pattern.

Additionally, the at least one piezoresistive sensor may include at least two different sensor arrangements, and the device may further include a processor to select one of the at least two different sensor arrangements based on a desired sensitivity or based on an application being run on the device.

Additionally, the device may include a force calculating component coupled to the at least one piezoresistive sensor, to calculate the applied force based on a change in resistance in the at least one piezoresistive sensor, and a force response activating component to execute a plurality of actions, where each of the plurality of actions is executed in response to a different calculated force.

Additionally, the force response activating component may one of control an intensity of an action based on a calculated applied force, select an action from a plurality of actions based on the calculated applied force, or select a number of objects to include in an action, based on the calculated applied force.

Additionally, the device may include a mobile communication device.

Additionally, the input device may include a button, a touch screen, a liquid crystal display (LCD), a keyboard, a keypad, or a scroll wheel.

Additionally, the at least one piezoresistive sensor may include a well formed in the substrate, a first diffusion region formed at a first end of the well, where the first diffusion region has a higher doping concentration than the well, a second diffusion region formed at a second end of the well, where the second diffusion region has a higher doping concentration than the well, a first contact coupled to the first diffusion region, and a second contact coupled to the second diffusion region.

In another aspect, a device is provided. The device may include a display formed on a substrate, at least one piezoresistive sensor formed on the substrate to sense a change in resistance based on a force applied to the display, a memory to store a plurality of instructions, and a processor to execute instructions in the memory to receive the sensed change in resistance, calculate an applied force based on the sensed change in resistance, activate a force response based on the applied force, and provide an indication of the activated force response via the display.

Additionally, the at least one piezoresistive sensor may be located outside an area of the substrate occupied by the display.

Additionally, the at least one piezoresistive sensor may be located within an area of the substrate occupied by the display.

In another aspect, a method is provided. The method may include monitoring a resistance associated with one or more piezoresistive sensors to detect changes in a force applied to a display device, detecting a change in resistance associated with the one or more piezoresistive sensors, calculating a force applied to the display device, based on the detected change in resistance, activating a force response in proportion to the calculated applied force, and displaying a result of the force response via the display device.

Additionally, the method may include calibrating the one or more piezoresistive sensors.

Additionally, the method may include adjusting a sensitivity of the one or more piezoresistive sensors by one of selecting an arrangement of the one or more piezoresistive sensors, selecting a length of sensors of the one or more piezoresistive sensors, or adjusting a gain of an amplifier coupled to the one or more piezoresistive sensors.

Additionally, activating a force response may include one or more of changing a brightness of the display device, changing a speed of scrolling, changing a speed of zooming, changing a volume of a speaker, selecting contents displayed on the display device, activating a single click of a pointing device, or activating a double click of the pointing device.

Additionally, activating a force response may include activating an action from a plurality of actions, the action being selected based on the calculated applied force.

Additionally, activating a force response may include controlling an intensity of an action based on the calculated applied force.

### BRIEF DESCRIPTION OF THE DRAWINGS

The accompanying drawings, which are incorporated in and constitute a part of this specification, illustrate one or more systems and/or methods described herein and, together with the description, explain these systems and/or methods. In the drawings:

FIG. 1 is a diagram of an exemplary mobile communication device in which systems and/or methods described herein may be implemented;

FIG. 2 is a diagram illustrating exemplary components of the mobile communication device of FIG. 1;

FIG. 3A illustrates a first exemplary sensor arrangement for a display of the mobile communication device depicted in FIG. 1;

FIG. 3B illustrates a second exemplary sensor arrangement for the display of the mobile communication device depicted in FIG. 1;

FIG. 4A illustrates an exemplary sensor arrangement for the display of the mobile communication device depicted in FIG. 1;

FIG. 4B illustrates a circuit schematic for the sensor arrangement of FIG. 4A;

FIG. 5 illustrates a first exemplary position of a piezoresistive sensor within the display of the mobile communication device depicted in FIG. 1;

FIG. 6 illustrates a second exemplary position of a piezoresistive sensor within the display of the mobile communication device depicted in FIG. 1;

FIG. 7 illustrates a first exemplary sensor capable of use with the mobile communication device depicted in FIG. 1;

FIG. 8 illustrates a second exemplary sensor capable of use with the mobile communication device depicted in FIG. 1;

FIG. 9 is a flow diagram illustrating a process for providing sensors in a display according to an exemplary implementation; and

FIG. 10 is a flow diagram illustrating a process for detecting force with sensors provided in a display according to an exemplary implementation.

### DETAILED DESCRIPTION

The following detailed description refers to the accompanying drawings. The same reference numbers in different drawings identify the same or similar elements. Also, the following detailed description does not limit the invention.

Exemplary implementations described herein may be described in the context of a mobile communication device (or mobile terminal). A mobile communication device is an example of a device that can employ an input device (e.g., a piezoresistive force sensor) described herein, and should not be construed as limiting of the types or sizes of devices or applications that can include the input device described herein. For example, the input devices described herein may be used with a desktop device (e.g., a personal computer or workstation), a laptop computer, a personal digital assistant (PDA), a media playing device (e.g., an MPEG audio layer 3 (MP3) player, a digital video disc (DVD) player, a video game playing device), a household appliance (e.g., a microwave oven and/or appliance remote control), an automobile radio faceplate, a television, a computer screen, a point-of-sale terminal, an automated teller machine, an industrial device (e.g., test equipment, control equipment), or any other device that may utilize an input device.

Touch sensor displays or touch screens (e.g., provided in mobile communication devices) may react to a capacitance introduced by a user's finger. A capacitive touch sensor display (or panel) may include a first layer provided in the x-direction and a second layer provided in the y-direction. Together, the two layers may provide “x” and “y” coordinates associated with a user's finger on the touch sensor display when the user touches the display.

Systems and/or methods described herein may measure a force of the user's finger. Measurements of force may be used, for example, for touch and release operations or drag and drop operations. In one implementation, a force sensor may be provided in a display device (e.g., a touch screen) and may include a structure similar to a strain gauge that uses a piezoresistive effect provided in an unused silicon layer provided along edges and corners of the display. This unused silicon may be etched away during a manufacturing process. The silicon may be deposited on a glass substrate, and the glass substrate may act as a membrane. The force from a user's finger may cause a strain in this membrane, and this strain may be measured by the piezoresistive sensors. Therefore, the force from the user's finger may be measured.

A piezoresistive sensor may measure changes in electrical resistance as a result of strain from an applied mechanical force. The piezoresistive response of silicon may be particularly large compared to other materials. For example, the piezoresistive response of silicon may be about one-hundred times the piezoresistive response of typical metals. This change in resistance may not be based on geometric factors and thus may not depend on changes in length and area.

The piezoresistive effect in silicon may be understood by noting that electrons in the silicon's conduction band may be equally shared between six equivalent minima. When subjected to stress, however, some minima may increase in energy and some minima may decrease in energy, which may lead to lower and higher electron populations, respectively. As a result of this population difference, the average effective mass may be altered, which in turn may be reflected as a change in resistivity. Systems and/or methods described herein utilize this property of silicon, together with the unused areas of a silicon substrate provided in a display, to form piezoresistive sensors that may sense the force applied by a user's finger to the display. The additional cost of implementing piezoresistive sensors within unused silicon of a display may be very small, since the silicon already exists and no extra space may be needed.

### Exemplary Device

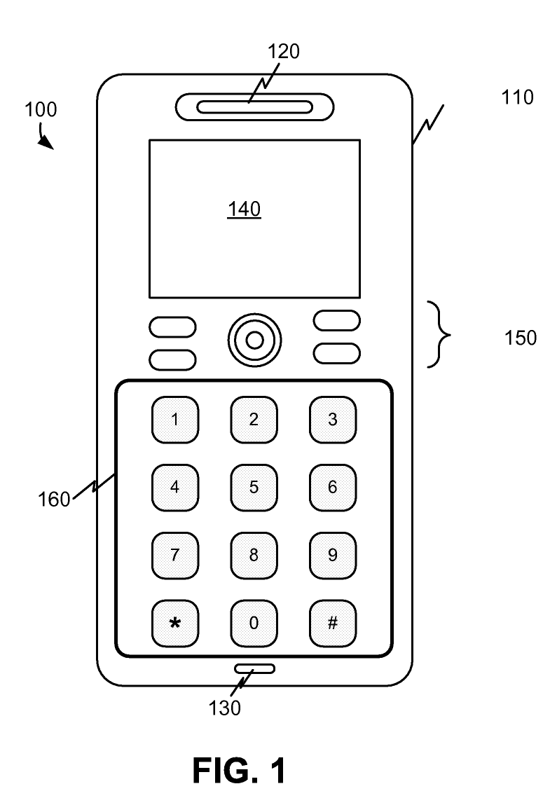

FIG. 1 is a diagram of an exemplary mobile communication device 100 in which systems and/or methods described herein may be implemented. As shown, mobile communication device 100 may include a cellular radiotelephone with or without a multi-line display; a personal communications system (PCS) terminal that may combine a cellular radiotelephone with data processing, facsimile and data communications capabilities; a PDA that may include a radiotelephone, pager, Internet/Intranet access, Web browser, organizer, calendar and/or a global positioning system (GPS) receiver; a laptop and/or palmtop receiver; or other appliances that include a radiotelephone transceiver. Mobile communication device 100 may also include media playing capability. As described above, systems and/or methods described herein may also be implemented in other devices that require user input, with or without communication functionality.

Referring to FIG. 1, mobile communication device 100 may include a housing 110, a speaker 120, a microphone 130, a display 140, control buttons or keys 150, and a keypad 160.

Housing 110 may protect the components of mobile communication device 100 from outside elements. Housing 110 may include a structure configured to hold devices and components used in mobile communication device 100, and may be formed from a variety of materials. For example, housing 110 may be formed from plastic, metal, or a composite, and may be configured to support speaker 120, microphone 130, and/or display 140.

Speaker 120 may provide audible information to a user of mobile communication device 100. Speaker 120 may be located in an upper portion of mobile communication device 100, and may function as an ear piece when a user is engaged in a communication session using mobile communication device 100. Speaker 120 may also function as an output device for music and/or audio information associated with games, voicemails, and/or video images played on mobile communication device 100.

Microphone 130 may receive audible information from the user. Microphone 130 may include a device that converts speech or other acoustic signals into electrical signals for use by mobile communication device 100. Microphone 130 may be located proximate to a lower side of mobile communication device 100.

Display 140 may provide visual information to the user. Display 140 may be a color display, such as a red, green, blue (RGB) display, a monochrome display or another type of display. In one implementation, display 140 may include a touch sensor display or a touch screen that may be configured to receive a user input when the user touches display 140. For example, the user may provide an input to display 140 directly, such as via the user's finger, or via other input objects, such as a stylus. User inputs received via display 140 may be processed by components and/or devices operating in mobile communication device 100. The touch screen display may permit the user to interact with mobile communication device 100 in order to cause mobile communication device 100 to perform one or more operations. In one exemplary implementation, display 140 may include a liquid crystal display (LCD) display. Display 140 may include a driver chip (not shown) to drive the operation of display 140.

Control buttons 150 may permit the user to interact with mobile communication device 100 to cause mobile communication device 100 to perform one or more operations, such as place a telephone call, play various media, etc. For example, control buttons 150 may include a dial button, a hang up button, a play button, etc.

Keypad 160 may include a telephone keypad used to input information into mobile communication device 100.

In an exemplary implementation, control buttons 150 and/or keypad 160 may be part of display 140. Display 140, control buttons 150, and keypad 160 may be part of an optical touch screen display. In addition, in some implementations, different control buttons and keypad elements may be provided based on the particular mode in which mobile communication device 100 is operating. For example, when operating in a cell phone mode, a telephone keypad and control buttons associated with dialing, hanging up, etc., may be displayed by display 140. In other implementations, control buttons 150 and/or keypad 160 may not be part of display 140 (i.e., may not be part of an optical touch screen display).

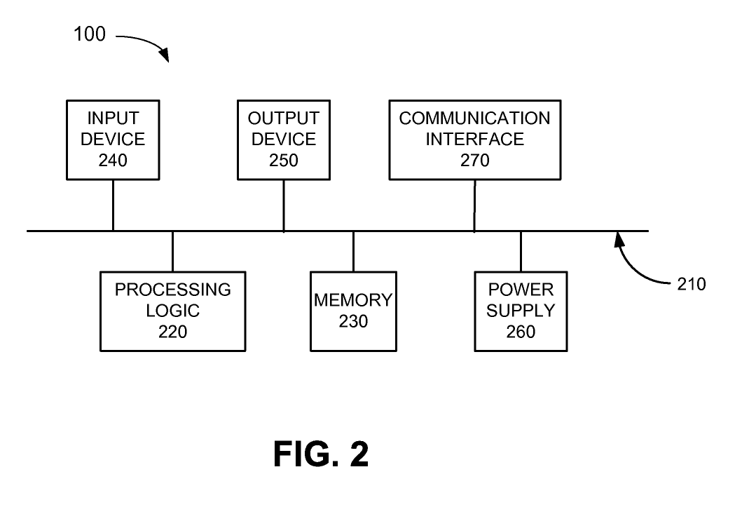

FIG. 2 is a diagram illustrating exemplary components of mobile communication device 100. As shown, mobile communication device 100 may include a bus 210, processing logic 220, memory 230, an input device 240, an output device 250, a power supply 260 and a communication interface 270. Mobile communication device 100 may be configured in a number of other ways and may include other or different elements. For example, mobile communication device 100 may include one or more modulators, demodulators, encoders, decoders, etc., for processing data.

Bus 210 may permit communication among the components of mobile communication device 100.

Processing logic 220 may include one or more processors, microprocessors, application specific integrated circuits (ASICs), field programmable gate arrays (FPGAs) or the like. Processing logic 220 may execute software instructions/programs or data structures to control operation of mobile communication device 100. In an exemplary implementation, processing logic 220 may include logic to control display 140. For example, processing logic 220 may determine whether a user has provided input to a touch screen portion of display 140, as described herein.

Memory 230 may include a random access memory (RAM) or another type of dynamic storage device that may store information and/or instructions for execution by processing logic 220; a read only memory (ROM) or another type of static storage device that may store static information and/or instructions for use by processing logic 220; a flash memory (e.g., an electrically erasable programmable read only memory (EEPROM)) device for storing information and/or instructions; and/or some other type of magnetic or optical recording medium and its corresponding drive. Memory 230 may also be used to store temporary variables or other intermediate information during execution of instructions by processing logic 220. Instructions used by processing logic 220 may also, or alternatively, be stored in another type of computer-readable medium accessible by processing logic 220. A computer-readable medium may be defined as a physical or logical memory device. A logical memory device may include memory space within a single physical memory device or spread across multiple physical memory devices.

Input device 240 may include mechanisms that permit a user to input information to mobile communication device 100, such as microphone 130, touch screen display 140, control buttons 150, keypad 160, a keyboard, a mouse, a pen, voice recognition and/or biometric mechanisms, etc. For example, as discussed above, all or a portion of display 140 may function as a touch screen input device for inputting information to mobile communication device 100.

Output device 250 may include one or more mechanisms that output information from mobile communication device 100, including a display, such as display 140, one or more speakers, such as speaker 120, etc. Power supply 260 may include one or more batteries or other power source components used to supply power to components of mobile communication device 100. Power supply 260 may also include control logic to control application of power from power supply 260 to one or more components of mobile communication device 100.

Communication interface 270 may include any transceiver-like mechanism that enables mobile communication device 100 to communicate with other devices and/or systems. For example, communication interface 270 may include a modem or an Ethernet interface to a LAN. Communication interface 270 may also include mechanisms for communicating via a network, such as a wireless network. For example, communication interface 270 may include one or more radio frequency (RF) transmitters, receivers and/or transceivers. Communication interface 270 may also include one or more antennas for transmitting and receiving RF data.

Mobile communication device 100 may provide a platform for a user to make and receive telephone calls, send and receive electronic mail or text messages, play various media, such as music files, video files, multi-media files, or games, and execute various other applications. Mobile communication device 100 may also perform processing associated with display 140 when display 140 operates as a touch screen input device. Mobile communication device 100 may perform these operations in response to processing logic 220 executing sequences of instructions contained in a computer-readable storage medium, such as memory 230. Such instructions may be read into memory 230 from another computer-readable medium or another device via, for example, communication interface 270. In alternative embodiments, hard-wired circuitry may be used in place of or in combination with software instructions to implement processes described herein. Thus, implementations described herein are not limited to any specific combination of hardware circuitry and software.

### Exemplary Input Device

As described herein, input device 240 may include one or more sensors, such as an array of sensors. When input device 240 takes the form of a touch screen display, display 140 may include an array of sensors covering part of, or an entire area of, display 140. While the description that follows describes input device 240 as part of display 140, in other implementations, input device 240 may be separate from display 140. Input device 240 may include a button, a touch screen, a liquid crystal display (LCD), a keyboard, a keypad, or a scroll wheel.

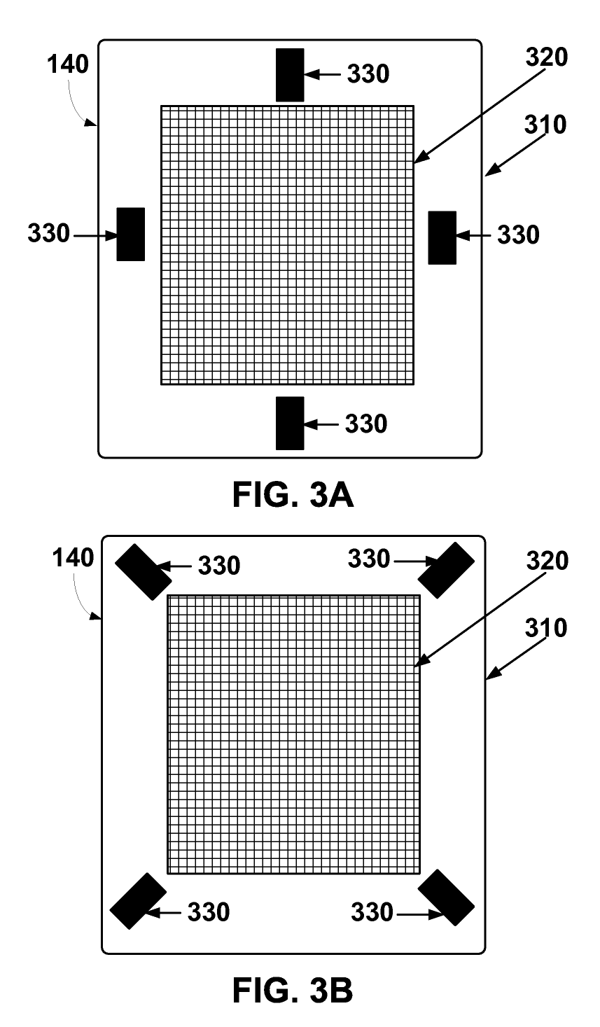

FIG. 3A illustrates a first exemplary sensor arrangement for display 140 of mobile communication device 100. As shown in FIG. 3A, display 140 may be a liquid crystal display (LCD) that includes a substrate 310 and a pixel array 320 formed on substrate 310. Substrate 310 may include a glass substrate with a layer of silicon, such as a silicon-on-insulator (SOI) substrate, a polymer substrate with a top layer of conductive polymer, etc.

Pixel array 320 may include, for example, black and white pixels, or color pixels. In the case of color pixels, each pixel may include one or more sub-pixels, such as, for example, a red sub-pixel, a green sub-pixel, and a blue sub-pixel. The sub-pixels may be arranged in any pattern, such as, for example, a triangular arrangement, a stripes arrangement, or a diagonal arrangement.

As further shown in FIG. 3A, substrate 310 may include piezoresistive sensors 330 formed on its periphery (e.g., in areas of unused silicon). Wires (not shown) may be routed to rows and columns of pixel array 320 and may be located above the silicon layer. Wires provided to sensors 330 may be located in a metal or indium tin oxide (ITO) layer along the edges of display 140, together with the wires routed to the pixels. FIG. 3A depicts an arrangement of four sensors 330, however, any number of sensors 330 may be used. Sensors 330 may be arranged on the sides of pixel array 310, and two of sensors 330 may sense deformations of substrate 310 in an X direction, and the other two of sensors 330 may sense deformations of substrate 310 in a Y direction.

FIG. 3B illustrates another exemplary sensor arrangement on substrate 3 10. As shown in FIG. 3B, one sensor 330 may be located in each corner of the display. The arrangement depicted in FIG. 3B may be used with a process (e.g., executed by processing logic 220), that calculates the X and Y position of a user's finger based on a force measured by sensors 330. In another implementation, the force measurement may be a single channel measurement when the X and Y coordinates are provided by, for example, a capacitive sensor included in display 140.

Factors that may influence the arrangement of piezoresistive sensors 330 on substrate 310 may include the presence of other components in display 140, the sensitivity of sensors 330, whether or not calibration of sensors 330 is required, and particular applications for which sensors 330 may be used.

One issue that a silicon piezoresistive sensor may experience is a large temperature drift. Temperature drift refers to a change in the piezoresistive response with a change in temperature. For monocrystalline silicon, this change in the piezoresistive response may be up to one percent per degree Kelvin. One way of compensating for temperature drift may be through processing logic 220. For example, a dedicated signal processor integrated circuit chip may be used for temperature drift compensations. In another implementation, processes for temperature drift compensations may be implemented at an application level of mobile communication device 100. In yet another implementation, temperature drift may be compensated for with a particular arrangement of sensors 330.

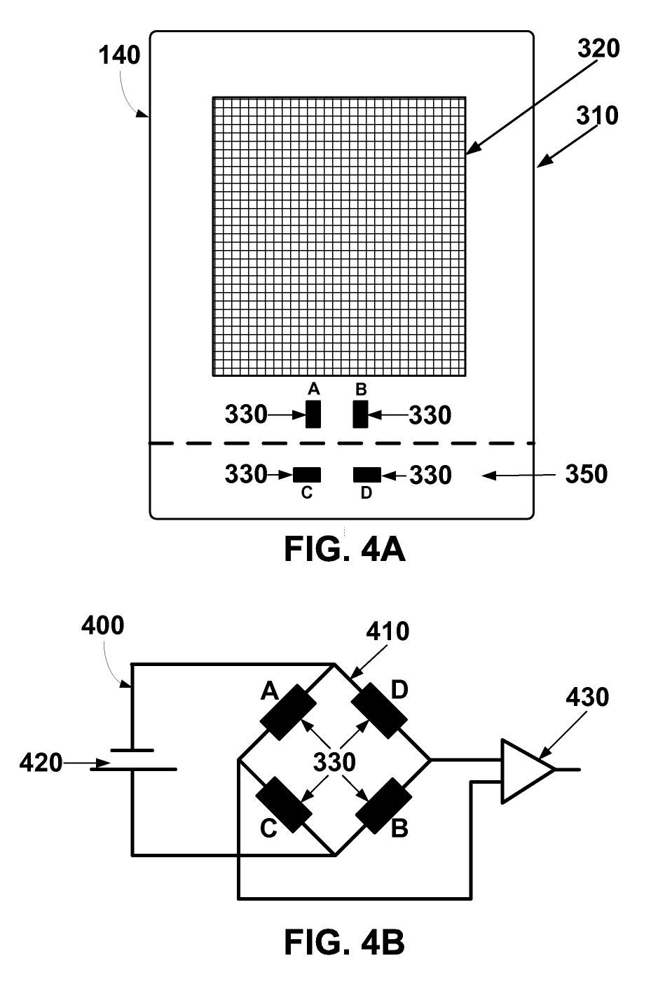

FIG. 4A depicts an exemplary sensor arrangement that may be used to minimize or eliminate temperature drift. As shown, a portion of substrate 310 may be mechanically isolated from the rest of substrate 310 to form strain-free area 350. Strain-free area 350 may be formed by physically separating strain-free area 350 from the rest of substrate 310, and may be formed by mounting a portion of substrate 310 to a stiff background. Strain-free area 350 may be mounted to the stiff background over its entire area or at a ridge separating it from the rest of substrate 3 10.

As further shown in FIG. 4A, two of sensors 330 (e.g., sensors A and B) may be located on a main area of substrate 310 that may be subjected to strain deformations when a force is applied to display 140. The other two sensors 330 (e.g., sensors C and D) may be located in a strain-free area 350 of substrate 310, which may not be subjected to strain deformation when a force is applied to display 140.

FIG. 4B depicts a circuit schematic 400 of the sensor arrangement of FIG. 4A. As shown, sensors 330 may be arranged in a Wheatstone bridge 410 connected to a power source 420 and an amplifier 430. Sensors A and B may be affected by strain and sensors C and D may not be affected by strain. As a result, the temperature drift may be canceled by Wheatstone bridge 410. The signal from Wheatstone bridge 410 may be amplified through amplifier 430. An analog amplifier may be integrated into the unused silicon area of display 140. After the signal has been amplified, the analog signal may be converted to a digital signal.

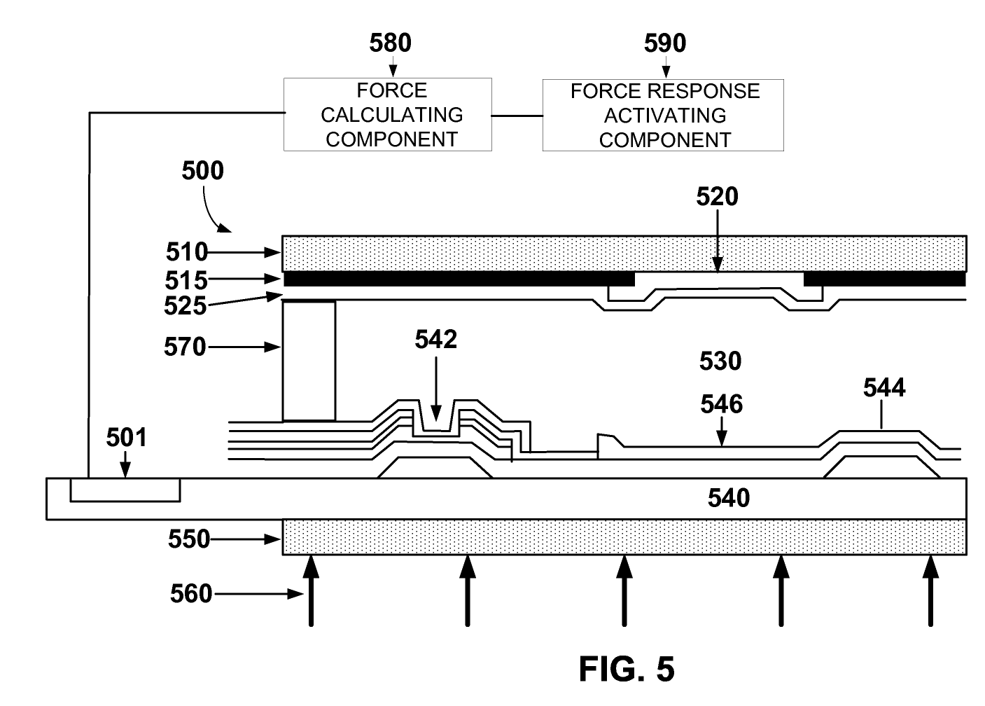

FIG. 5 illustrates a first exemplary position of a piezoresistive sensor 501 within an LCD display 500 (e.g., display 140). While only one piezoresistive sensor 501 is depicted in FIG. 5, LCD display 500 may include multiple piezoresistive sensors arranged around the periphery. LCD display 500 may include a top polarizing filter 510 for polarizing the light exiting LCD display 500, and a black matrix filter 515 for blocking light that does not exit through a color filter 520. LCD display 500 may further include a top indium tin oxide (ITO) electrode 525 and a liquid crystal layer 530. Liquid crystal layer 530 may react to a voltage applied between top electrode 525 and a bottom electrode 546. Bottom electrode 546 may be formed in a silicon layer 540. Silicon layer 540 may include thin film transistor (TFT) transistor 542 and a storage capacitor 544 for driving a pixel.

A bottom polarizing filter 550 may be formed below silicon layer 540. Light 560 may be applied from the bottom of LCD display 500 by a backlight (not shown). When no voltage bias is applied between bottom electrode 546 and top electrode 525, light may be polarized by bottom polarizing filter 550 and rotated by birefringent liquid crystal layer 530, allowing it to pass through top polarizing filter 510. When a voltage bias is applied between bottom electrode 546 and top electrode 525, the light passing through liquid crystal material 530 may not be rotated and may be blocked by top polarizing filter 510.

A row or column of pixels may be at the edge of LCD display 500 (e.g. pixel array 320), and may include a seal 570. FIG. 5 illustrates an LCD pixel at the edge of pixel area 320. Sensor 501 may be formed in silicon layer 540 outside seal 570, and in a portion of silicon layer 540 not used by LCD display 500. In another exemplary implementation, sensor 501 may be formed in an area enclosed by seal 570.

As further shown in FIG. 5, sensor 501 may be coupled to a force calculating component 580. Force calculating component 580 may be configured to calculate the amount of force applied to LCD display 500 (or pixel array 320), by receiving a measurement of a change in resistance detected by piezoresistive sensor 501.

Force calculating component 580 may be coupled to an array of piezoresistive sensors and configured to determine the change in resistance detected by each particular sensor in the array. Based on the change in resistance detected by each particular sensor and based on the arrangement of the sensors, force calculating component 580 may determine the location of the applied force on LCD display 500 (or pixel array 320). For example, force calculating component 580 may determine the X and Y coordinates of the applied force in pixel array 320.

Force calculating component 580 may be configured to adjust the sensitivity of one or more piezoresistive sensors to which it is coupled. The sensitivity of the piezoresistive sensors may be adjusted by adjusting the gain of an amplifier coupled to the piezoresistive sensors. Force calculating component 580 may include an amplifier, or an amplifier may be provided separate from force calculating component 580. Additionally, mobile communication device 100 may include multiple sensor arrangements. For example, mobile communication device may include one or more of the sensor arrangements depicted in FIGS. 3A, 3B, and 4A. Force calculating component 580 may be configured to select one of a plurality of sensor arrangements that are present in mobile communication device 100. For example, the sensor arrangement may be selected based on the requirements of an application of mobile communication device 100 or based on a desired sensitivity. Additionally, mobile communication device 100 may include individual piezoresistive sensors having different sensitivities. For example, individual piezoresistive sensors may have different lengths, where a particular length of a piezoresistive sensor may impart a different sensitivity. Force calculating component 580 may select a particular piezoresistive sensor based on a desired sensitivity. Force calculating component 580 may be implemented, for example, within processing logic 220, or as a processor, microprocessor, an application specific integrated circuit (ASIC), field programmable gate array (FPGA), or the like, within input device 240.

As further shown in FIG. 5, force calculating component 580 may be coupled to force response activating component 590. Force response activating component 590 may be configured to activate a force response based on the applied force that is calculated by force calculating component 580.

The particular action or series of actions activated by force response activating component 590 in response to detecting a change in resistance in piezoresistive sensor 501 may be predetermined during manufacture, set by a user, or may depend on an application being executed by mobile communication device 100. Force response activating component 590 may be configured to activate the execution of a plurality of actions, where each of the plurality of actions is executed in response to a different range of change in resistance detected at piezoresistive sensor 501. Force response activating component 590 may be configured to control an intensity of an action or a number of objects to include in an action based on the change in resistance detected. Force response activating component 590 may be implemented, for example, within processing logic 220, or as a processor, microprocessor, an application specific integrated circuit (ASIC), field programmable gate array (FPGA), or the like, within input device 240.

Force response activating component 590 may activate a force response that may include one or more of changing the brightness of display device 140, changing the speed of scrolling, changing a speed of zooming, changing the volume of speaker 120, selecting contents being displayed on display device 140, activating a single click of a pointing device (such as a stylus, a tracking device, or a mouse), or activating a double click of a pointing device.

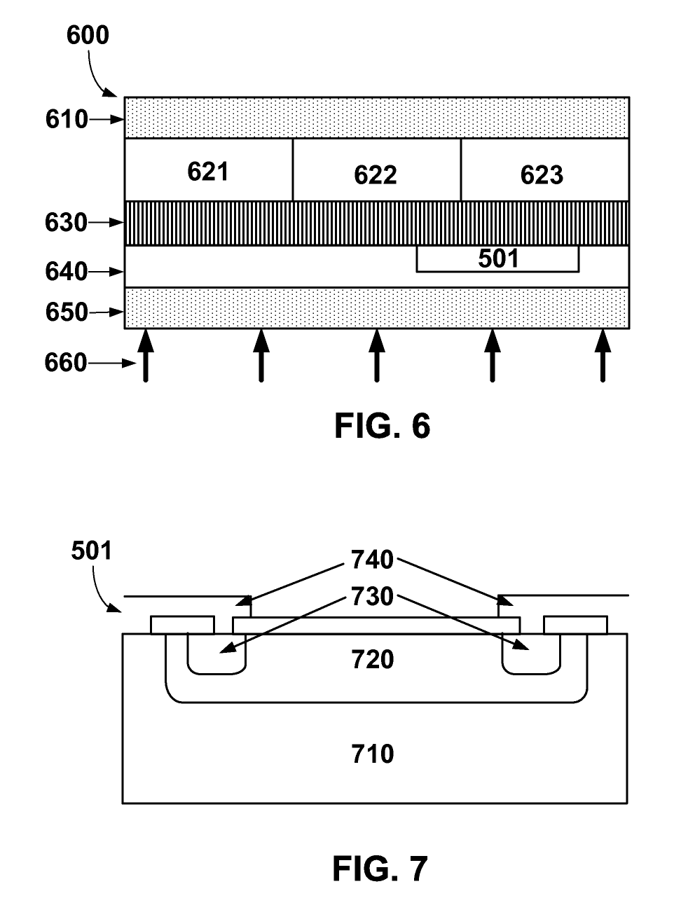

FIG. 6 illustrates a single LCD pixel 600 and another exemplary position of a piezoresistive sensor within an LCD display. As shown, single pixel 600 may include a top polarizing filter 610, a red color filter 621, a green color filter 622, and a blue color filter 623. Single pixel 600 may further include a liquid crystal material 630, a silicon layer 640, a bottom polarizing filter 650, and a backlight 660. Piezoresistive sensor 501 may be formed within silicon layer 640. Therefore, in this particular implementation, piezoresistive sensor 501 may be formed in the area encompassed by pixel array 320 of display 140. Piezoresistive sensor 501 may be formed in an area of pixel 600 where the transmission of light through pixel 600 is not obstructed. For example, sensor 501 may be formed in an area encompassed by black matrix filter 515 (shown in FIG. 5).

FIG. 7 illustrates exemplary components of sensor 501. As shown, sensor 501 may be include a substrate 710, such as a silicon substrate, and may be formed as a diffused resistor. Sensor 501 may be formed by forming a well in substrate 710, of the opposite semiconductor type. For example, sensor 501 may include an “n” type well 720 formed within a “p” type substrate (e.g., substrate 710). If substrate 710 is an “n” type substrate, well 720 may be a “p” type well. To facilitate forming an ohmic contact, diffusion region 730 may be formed within well 720 with a higher doping concentration. Diffusion region contacts 730 may be formed within “n” type well 720 as “n+” type ohmic contacts connecting the resistor to metal lines 740. Well 720 and diffusion region contacts 730 may be formed through diffusion or through ion implantation.

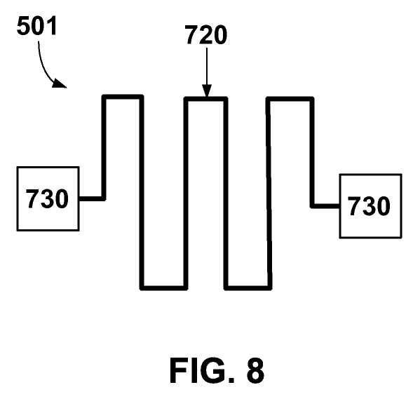

The structure of the silicon well (e.g., well 720) may be formed to increase the strain sensitivity of sensor 501. For example, FIG. 8 shows a zig-zagging foil patterned well 720 that connects to ohmic contacts 730. Well 720 may include any pattern, and may include a pattern that increases the length of well 720. Using a zig-zagging foil pattern such as depicted in FIG. 8, the sensitivity of sensor 501 may be very high, such as a resolution of ten (10) Pascals, while using a very small area.

In another implementation, substrate 710 may include a polymer substrate and sensor 501 may be a polymeric piezoresistive sensor, or a composite piezoresistive sensor.

### Exemplary Processes

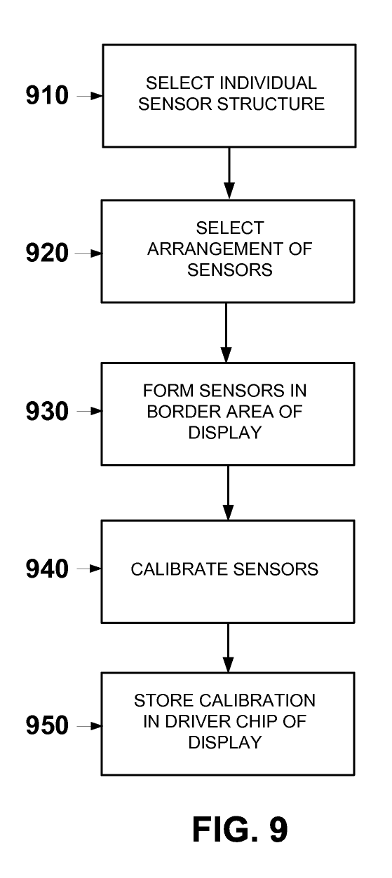

FIG. 9 is a flow diagram illustrating a process for providing sensors in a display according to an exemplary implementation. FIG. 9 also depicts a process that may be used for manufacturing and calibrating display device 140. As shown, the process may begin by an individual sensor structure being selected (block 910), such as the sensor structure depicted in FIG. 8. An arrangement of sensors may be selected (block 920), such as the arrangement depicted in FIG. 3A, or the arrangement depicted in FIG. 3B. In another implementation, an arrangement of sensors may be selected during use of mobile communication device 100. For example, multiple arrangements of sensors may be provided on display device 140, and a particular arrangement may be selected based on an application being run by mobile communication device 100. For example, different applications may require different sensitivities of force detection, and different arrangements of piezoresistive sensors may provide different sensitivities of force detection.

Sensors may be formed in a border area of a display device (block 930). In another implementation, sensors may be formed within a pixel array area of the display device. The sensors may be calibrated (block 940). In one implementation, calibration may not be needed, and only a relative measurement of the force may be needed. In such an implementation, when a user first touches a display, a first force measurement may be taken. The next measurement may then be related to the first measurement, and may identify whether there was an increase or decrease in force.

If a more accurate measurement is needed, the force measurements may be calibrated based on using an existing capacitive touch sensor, which may be present in display 140. If a user applies force with a finger to a part of display 140, different parts of display 140 may experience different amounts of strain. For example, if a user presses a part of display 140 near the edge of display 140 and near one of sensors 330, the strain will be higher than if the user presses a part of display 140 away from one of sensors 330. A capacitive touch sensor may be used to calculate the X and Y position of the applied force. A calibration matrix based on X and Y positions may exist to calibrate the force measurement based on the particular X and Y position.

Calibration information for the display may be stored in a driver chip of display 140 (block 950). In another implementation, calibration information may be included within force calculating component 580. An independent calibration may be performed for each individual display. In another implementation, calibration may be performed during use, rather than, or in addition to, during manufacture.

For example, when mobile communication device 100 is in use, a user may be prompted to calibrate display 140 by being prompted to touch display 140 at various locations and with various degrees of applied force, and an indication of the location and amount of applied force may be displayed on display 140. The user may then be asked to confirm the indication. For example, a series of bars may be displayed on display 140, and the user may be asked to press lightly. In response to pressing lightly, a single bar might light up. The user may then be asked to press with a medium pressure, and a second bar might light up. The user may then be asked to press with a heavy pressure, and a third bar might light up. The user then may be asked to confirm that this is the amount of pressure the user would like to use to correspond to a light, medium, and a heavy pressure. The light, medium, and heavy pressures might be assigned to correspond, by force calculating component 580, to three different measurable forces, which may correspond to three different actions activated by force response activating component 590. For example, the light pressure might be assigned to scrolling, a medium pressure might be assigned to selecting text, and a heavy pressure might be assigned to activating text (such as a selecting a displayed hyperlink or calling a displayed phone number).

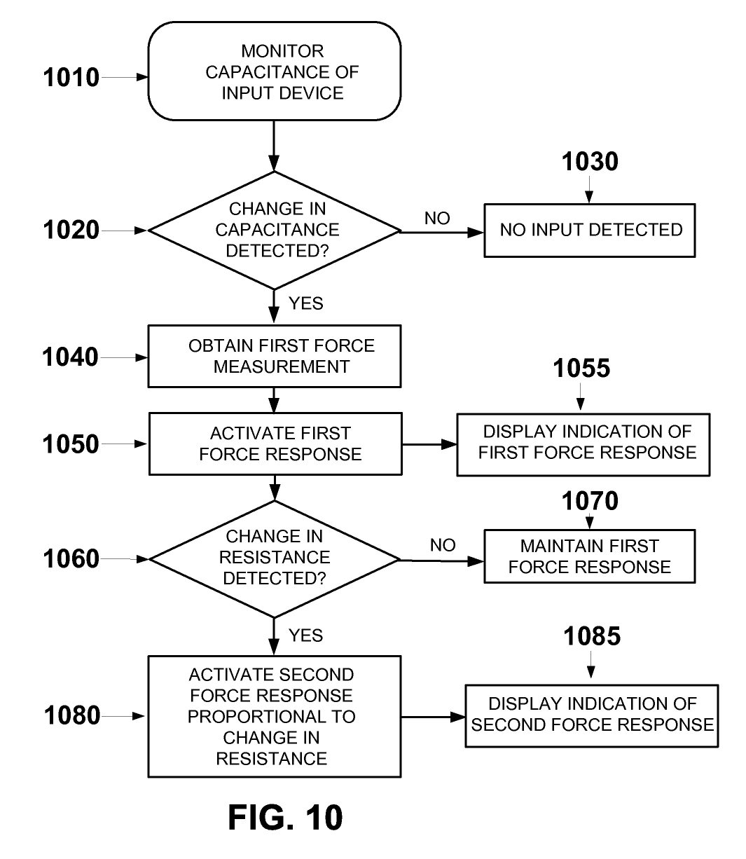

FIG. 10 is a flow diagram illustrating a process for detecting force with sensors provided in a display according to an exemplary implementation. The process may begin with monitoring a change in capacitance of an input device (block 1010). For example, display device 140 may include capacitive sensing, and a change in capacitance may indicate a user's finger on display device 140. If no change in capacitance is detected (block 1020—NO), an input may not be detected (block 1030). If a change in capacitance is detected (block 1020—YES), a first force measurement may be obtained (block 1040). The first force measurement may be obtained by measuring a change in resistance of a piezoresistive sensor, such as piezoresistive sensor 501. The X and Y location of the first force measurement may be provided using the capacitive touch sensor, and automatic calibration may be performed based on the provided X and Y location of the first force measurement. In another implementation, the process may begin with a first force measurement (block 1040).

A first force response may be activated in response to the first force measurement (block 1050) and an indication of the first force response may be displayed (block 1055). For example, the contents displayed by display device 140 may be scrolled at a first speed. A change in resistance (e.g. of sensor 501) may be monitored continuously or at discrete time intervals. If no change in resistance is detected (block 1060—NO), the first force response may be maintained (block 1070). For example, the scrolling speed of the contents being displayed by display device 140 may be maintained. If a change in resistance is detected (block 1060—YES), a second force response may be activated (block 1080) and an indication of the second force response may be displayed (block 1085). The second force response may be activated in proportion to the change in resistance. For example, if a large change in resistance was measured, corresponding to a relatively large force being applied, the second force response may be higher in intensity. For example, if a larger force is applied to display device 140, a corresponding larger change in resistance may be detected, and the speed of scrolling of the contents being displayed by display device 140 may increase.

A result of the force response may be displayed on display 140, either directly or indirectly (blocks 1055 and 1085). For example, if the force response is configured to change the brightness of display device 140 or select contents being displayed on display 140, the result of the force response may be directly visible. If the force response is configured for a result that may not be directly visible, an indication of the result of the force response may be provided on display 140. For example, if the force response is configured to change the volume of speaker 120, an icon representing the volume may be displayed on display 140, indicating the volume has been changed.

The force response may be configured to control an intensity of an action or the number of objects to include in the action based on the amount in the change of resistance and therefore based on the amount of force detected. The force response may be configured to indicate the degree or intensity of an input action by the user along a continuous spectrum. For example, if input device 240 is a touch screen, the amount of force a user applies with a finger may control the brightness of the touch screen, speed of scrolling through the contents being displayed on the touch screen, the speed of zooming through the contents displayed on the touch screen, how many pages of a virtual book to turn, the speed of an element in a game, or the volume of speaker 130. Some of the examples given above may require that a user move a finger across a part of the input device 240. For example, if the force response is configured to control the speed of scrolling through the contents being displayed, the user may slide a finger across a portion of the display device while applying pressure to indicate the direction of scrolling, where the pressure being applied may determine how fast the displayed contents are scrolled. In one implementation, only two states may be used, a light touch and a heavy touch. A light touch may be used to highlight an icon being displayed, and a heavy touch may be used to execute the function of the icon.

The force response may be configured with a discrete set of responses based on the applied force. For example, if input device 240 is a keyboard or a set of keys, or if an image of a keyboard is displayed on display 140, different amounts of force may be configured to cause the pressed key to have different functions. For example, for a keyboard, a light touch might cause the keys to function as lower case letters, a medium touch as capital letters, and a heavy touch as control key characters. Alternatively, due to limited space on mobile communication device 100, input device 240 may not be a full keyboard, and each key may be used for multiple letters. In such an implementation, a light touch might cause a key to input one letter, a medium touch might cause a key to input a second letter, and a heavy touch might cause a key to input a third letter.

In one implementation, a capacitive touch sensor may be used along with piezoresistive strain sensors to obtain different functions. For example, if input device 240 is a touch screen, a light touch activating the capacitive response may select a link displayed on the touch screen, while a force response based on a piezoresistive sensor measurement may select text displayed on the touch screen. As another example, a light touch activating a capacitive response may be used to scroll through the contents being displayed, while a touch activating a force response may act to select some of the contents.

### CONCLUSION

Implementations described here may provide an input device capable of detecting a user's touch through a change in resistance and detecting the amount of force a user is applying to the input device by detecting a change in resistance as a result of a piezoresistive response in a sensing layer of the input device. The piezoresistive sensors of the input device may be, for example, arranged in the periphery, or border area, of a display device in unused areas of the display device. The change in resistance from the piezoresistive response may be used to activate a force response, so as to control an intensity of an action or the number of objects to include in the action based on the amount in the change of voltage and therefore based on the amount of force detected.

The foregoing description provides illustration and description, but is not intended to be exhaustive or to limit the invention to the precise form disclosed. Modifications and variations are possible in light of the above teachings or may be acquired from practice of the invention.

For example, while series of blocks have been described with respect to FIGS. 9 and 10, the order of the blocks may be modified in other implementations. Further, non-dependent blocks may be performed in parallel.

Still further, aspects have been mainly described in the context of a mobile communication device. As discussed above, the device and methods described herein may be used with any type of device that includes an input device. It should also be understood that particular materials discussed above are exemplary only and other materials may be used in alternative implementations to generate the desired information.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain aspects described herein may be implemented as “logic” that performs one or more functions. This logic may include hardware, such as a processor, microprocessor, an application specific integrated circuit or a field programmable gate array, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A device, comprising:
a substrate;
an input device provided on a first portion of the substrate; and
at least one piezoresistive sensor to sense a force applied to the input device, where the piezoresistive sensor is provided on a second portion of the substrate, where the second portion is different than the first portion.

2. The device of claim 1, where the at least one piezoresistive sensor comprises at least one of a piezoresistive sensor located outside each corner of the input device, or a piezoresistive sensor located outside a middle of each edge of the input device.

3. The device of claim 1, where the at least one piezoresistive sensor comprises:
a first pair of piezoresistive sensors formed in a deformable area of the substrate; and
a second pair of piezoresistive sensors formed in a substantially non-deformable area of the substrate.

4. The device of claim 3, where the first pair of piezoresistive sensors and the second pair of piezoresistive sensors are arranged in a Wheatstone bridge configuration.

5. The device of claim 1, where the at least one piezoresistive sensor comprises a sensor having a zigzag pattern.

6. The device of claim 1, where the at least one piezoresistive sensor comprises at least two different sensor arrangements, and the device further comprises:
a processor to select one of the at least two different sensor arrangements based on a desired sensitivity or based on an application being run on the device.

7. The device of claim 1, further comprising:
a force calculating component coupled to the at least one piezoresistive sensor, to calculate the applied force based on a change in resistance in the at least one piezoresistive sensor; and
a force response activating component to execute a plurality of actions, where each of the plurality of actions is executed in response to a different calculated applied force.

8. The device of claim 7, where the force response activating component one of:
controls an intensity of an action based on a calculated applied force, selects an action from a plurality of actions based on the calculated applied force, or selects a number of objects to include in an action based on the calculated applied force.

9. The device of claim 1, where the device comprises a mobile communication device.

10. The device of claim 1, where the input device comprises a button, a touch screen, a liquid crystal display (LCD), a keyboard, a keypad, or a scroll wheel.

11. The device of claim 1, where the at least one piezoresistive sensor comprises:
a well formed in the substrate;
a first diffusion region formed at a first end of the well, where the first diffusion region has a higher doping concentration than the well;
a second diffusion region formed at a second end of the well, where the second diffusion region has a higher doping concentration than the well;
a first contact coupled to the first diffusion region; and
a second contact coupled to the second diffusion region.

12. A device, comprising:
a display formed on a substrate;
at least one piezoresistive sensor formed on the substrate to sense a change in resistance based on a force applied to the display;
a memory to store a plurality of instructions; and
a processor to execute instructions in the memory to:
receive the sensed change in resistance,
calculate an applied force based on the sensed change in resistance,
activate a force response based on the applied force, and
provide an indication of the activated force response via the display.

13. The device of claim 12, where the at least one piezoresistive sensor is located outside an area of the substrate occupied by the display.

14. The device of claim 12, where the at least one piezoresistive sensor is located within an area of the substrate occupied by the display.

15. A method implemented by an input device, the method comprising:
monitoring a resistance associated with one or more piezoresistive sensors to detect changes in a force applied to a display device;
detecting a change in resistance associated with the one or more piezoresistive sensors;
calculating a force applied to the display device, based on the detected change in resistance;
activating a force response in proportion to the calculated applied force; and
displaying a result of the force response via the display device.

16. The method of claim 15, further comprising:
calibrating the one or more piezoresistive sensors.

17. The method of claim 15, further comprising:
adjusting a sensitivity of the one or more piezoresistive sensors by one of:
selecting an arrangement of the one or more piezoresistive sensors, selecting a length of sensors of the one or more piezoresistive sensors, or adjusting a gain of an amplifier coupled to the one or more piezoresistive sensors.

18. The method of claim 15, where activating a force response comprises one of more of:
changing a brightness of the display device,
changing a speed of scrolling,
changing a speed of zooming,
changing a volume of a speaker,
selecting contents displayed on the display device,
activating a single click of a pointing device, or
activating a double click of the pointing device.

19. The method of claim 15, where activating a force response comprises:
activating an action selected from a plurality of actions, the action being selected based on the calculated applied force.

20. The method of claim 15, where activating a force response comprises:
controlling an intensity of an action or a number of objects to include in an action, based on the calculated applied force.
